(19) United States
(12) Patent Application Publication
(10) Pub. No.: US 2006/0289477 A1
(43) Pub. Date: Dec. 28, 2006

(54) Folded heater element and method of manufacturing same

(75) Inventor: Thomas Gschwind, Bad Durkheim (DE)

Correspondence Address: SEED INTELLECTUAL PROPERTY LAW GROUP PLLC, 701 FIFTH AVE, SUITE 5400, SEATTLE, WA, 98104, US

(73) Assignee: DBK David + Baader GmbH, Kandel (DE)

(21) Appl. No.: 11/377,239

(22) Filed: Mar. 15, 2006

(30) Foreign Application Priority Data
Mar. 17, 2005 (DE) 102005012891.2

(51) Int. Cl. H05B 3/54; H05B 3/34

(52) U.S. Cl. 219/549

(57) ABSTRACT

The invention relates to a folded heater element and a method of manufacturing a through-flow spatial structure in a folded heater element of a track material of a heater substance lying in an initial surface, whereby in the track material a heater meander is produced by parting the track material into single heater limbs connected to one another at the ends at connection zones and the heater meander is shaped out of the initial surface to form the through-flow spatial structure. In order to improve folded heater elements and their manufacturing methods such that they can be manufactured more economically and with a more flexible spatial structure, it is provided according to the invention that at least some connection zones are offset with respect to other connection zones and in achieving this the heater limbs connected to the connection zones are moved relative to one another and thereby a heater network is produced from the heater limbs.

### BACKGROUND OF THE INVENTION

1. Field of the Invention

The invention in some embodiments generally relates to a method of manufacturing a through-flow spatial structure in a folded heater element of a track material of a heater substance lying in an initial surface, whereby in the track material a heater meander is produced by parting the track material into single heater limbs connected to one another at the ends at connection zones and the heater meander is shaped from the initial surface to form the through-flow spatial structure.

The invention in some embodiments also generally relates to a folded heater element with a spatial structure arranged for through flow, in particular for an electrical heating appliance for heating a flowing fluid, whereby the folded heater element is produced from an essentially planar track material of a heater substance, the track material is formed as a heater meander with heater limbs, separated from one another by parting edges and connected to one another at the ends at connection zones, and parts of the heater meander are shaped to form a spatial structure.

2. Description of the Related Art

Folded heater elements of the type described above are known from the state of the art and are used for heating fluids, e.g., in tumble dryer heaters, fan heaters, industrial hot blowers, etc.

In EP 0 335 210 A1 a method for the manufacture of a heater element with a spatial structure is described which is produced from a metal sheet or a metal foil. Here, first a planar meander structure is cut, stamped or etched out of the metal foil, whereby a planar meander strip heater is produced. The parallel running heater limbs of this meander strip heater runs V- or arc-shaped between the connecting points at which the heater limbs are joined together. In a second working step the heater limbs are bent alternately in opposite directions from the surface of the planar heater meander. Actually, folding takes place in the transition region of the heater limb to the connection points so that the V- or arc-shaped heater limbs are erected, thus forming the spatial structure of the heater element.

A disadvantage with the manufacturing method of EP 0 335 210 A1 is that during the manufacture of the heater meanders a relatively large amount of wastage arises. Furthermore, it should be noted that the spatial structure of the heater element is already determined by the punched shape of the heater limbs and is consequently relatively inflexible, because it can only be varied by changing the punch die.

A similar method of manufacturing a folded heater element is disclosed in FR 2 608 883 A1. Also, in this publication a heater meander is punched out of a planar metal sheet, the heating limbs of which are formed V-shaped between the connection points. With FR 2 608 883 A1 all the heater limbs are bent out to one side from the plane of the meander, whereby the bending, as with EP 0 335 210 A1, occurs in the transition region between the heater limbs and the connection points.

Due to the bending out of the heater limbs, a spatial structured heater meander arises similar to a V-shaped channel, whereby the shape of the channel is defined by the shape of the punched out heater limbs.

Other folded sheet heater elements are for example known from DE-C-650 676, GB-A-361,986 or U.S. Pat. No. 2,568,169.

A problem with the heater element of FR 2 608 883 A1 is, similar to EP 0 335 210 A1, the high costs due to a large amount of material wastage during production. Furthermore, the spatial structure of the heater element is essentially determined by the shape of the punched out heater limb, whereby the structure is relatively inflexible.

### BRIEF SUMMARY OF THE INVENTION

In view of these problems the object of the invention is to improve the known folded heater elements and their manufacturing methods so that the folded heater elements can be manufactured more economically and with a flexible spatial structure, which additionally leads to improved heating of the fluid.

According to some embodiments of the invention this object is resolved for the method in that at least some connection zones are offset compared to other connection zones and thereby the heater limbs connected to the connection zones are splayed out relative to one another.

For the folded heater element according to the invention this object is resolved in that in each case the heater limbs connected in a connection zone are splayed out and that the connection zones are spaced from one another.

These constructively, surprisingly simple solutions facilitate an almost waste-free and thus economical production of the folded heater element with a spatial structure that can be arranged variably.

Offsetting of the connection zones leads to splaying out and spacing of the heater limbs with respect to one another, whereby contacts between adjacent heater limbs which may cause short circuits are avoided. Spacing of the heater limbs by removing track material during separation, as with the heater elements in the state of the art, is not necessary and the material costs are reduced. During the manufacture of the planar heater meander, the heater limbs can, in contrast to the methods of EP 0 355 210 A1 and FR 2 608 883 A1, be formed by very narrow separating edges, whereby almost the complete track material can be used as effective heater sheet.

A further advantage of some embodiments of the invention is that the spatial structure is determined by the displacement of the connection zones and not by the shape of the heater limb of the heater meander as in the state of the art. Through differently offsetting the connection zones with respect to other connection zones the spatial structure of the folded heater element according to some embodiments of the invention can be designed variably and individually and adapted to almost any heating appliance requirements.

The formation of the spatial structure according to some embodiments of the invention also leads to better through flow and heating of the fluid.

The folded heater element according to some embodiments of the invention and the method of manufacturing the same can be further developed through different respectively advantageous arrangements which are independent of one another. These embodiments and the advantages associated with the respective embodiments are briefly explained in the following.

The heater limbs can form a heater network in which the connection zones are arranged offset to one another and the projections of the heater limbs cross in the longitudinal direction of the heater meander. This has the advantage that the crossed heater limbs heat a fluid flow better. In the manufacturing method according to some embodiments of the invention, a heater network can be produced out of crossing heater limbs in a projection in the longitudinal direction of the heater meander due to the offsetting of the connection zones and the splaying out of the heater limbs.

In a further embodiment of the method the track material in the region of the heater limb can be separated essentially free of wastage to reduce the amount of material required. Since the track material is just slit on the parting edges, hardly any material wastage arises so that the surface of the heater meander in the region of the heater limb essentially corresponds to the surface of the planar track material in the same region before parting. Furthermore, essentially linear heater limbs are produced by the parting.

Punching, etching or cutting can, for example, be employed as parting methods. In particular, mechanical water jet or thermal laser cutting are advantageous here, because with these methods only the slightest amounts of track material are removed.

In another advantageous embodiment of the folded heater element according to the invention the distance between the parting edges of a heater limb can be greater than the distance between the adjacent parting edges of neighbouring heater limbs in order to minimise the wastage during parting and also the material costs.

According to a further embodiment of the method according to the invention the connection zones can be displaced within the essentially planar initial surface. The displacement thereby causes bending of the heater limbs, each of which is located between two connection zones. Due to the bending of the heater limbs they protrude out from the initial surface and form the through-flow spatial structure. The advantage of the displacement of the connection zones within the initial surface is that the connection zones remaining in the initial surface can be fitted in a simple manner, for example to a mounting plate.

Alternatively, the connection zones can be displaced essentially perpendicular to the initial surface in order to form the spatial structure. In this case the spatial structure is formed in that straight heater conductors of connection zones within the initial surface run to connection zones outside of the initial surface and vice versa.

If the arrangement of the connection zones within the initial plane is combined with the arrangement perpendicular to the initial plane, a large number of different spatial structures can be produced from one single planar heater meander shape.

A further advantageous embodiment is that in each case two connection zones connected together via a heater limb can be displaced in pairs. The displacement in pairs of directly consecutive connection zones has the effect that the displaced heater limbs firstly form a spatial structure and secondly are spatially spaced from one another. Consequently, the danger of short circuits due to the contacting of these heater limbs is eliminated, because the parting edges of adjacent heater limbs do not lie in a common plane.

In order to achieve even greater variability of the spatial structure of the folded heater element according to some embodiments of the invention, the track material can be shaped to form a spatial area out of the initial surface before the connection zones are displaced. The spatial area is a spatial, non-planar surface to which the essentially planar initial surface is reformed, such as for example through edges or bends. In this way the folded heater element can be particularly well adapted to the spatial conditions in which it is to be later used and the stability is increased.

The spatial area can be formed by a longitudinal bending of the heater limbs essentially perpendicular to the initial surface. In this way, the heater limbs are shaped, but not the connection zones. With the folded heater element the heater limbs can be shaped in the cross-section to the longitudinal direction in each case deviating from a straight line between the connection zones. For example, the heater limbs can be bent or folded arc or angular shaped with one or more folding axes. Consequently, the heater meander takes on a channel shape which is formed by the bent heater limbs. An additional advantage of the special arrangement is that the channel shape provides the heater element with improved stability.

The heater limbs of a heater meander can here all be displaced in an advantageous manner between the connection zones to the same side from the plane of the initial surface.

A particularly stable embodiment can be obtained in that the heater limbs are bent from at least one bending point. Thus, the folded heater element according to the invention can comprise a bending point, whereby the heater limbs are stiffened and a thermally dependent longitudinal expansion of the heater limbs can take place directionally. The bending point shortens the length of the straight heater limbs and also stiffens them in addition. Furthermore, during the expansion of the heater limbs on heating, the stresses, which occur preferentially in the longitudinal direction of a strip heater, are now concentrated at the bending point. Therefore, the stresses are specifically reduced at the bending location and prevent an uncontrolled longitudinal expansion leading to contacts with the adjacent heater limbs.

In order to further improve the stability of the folded heater element according to the invention, stiffening profiles can be formed in the track material according to another embodiment. The stiffening profiles, in particular crimps with an angular, arc-shaped, trapezoidal, box-shaped or semicircular cross-section, can in particular be formed in the regions of the track material in which the heater limbs run, so that the heater limbs are provided with longitudinal crimps.

To simplify the electrical connection of the heater element according to some embodiments of the invention to an energy source, at least one contact point and/or one contact strip of the folded heater element can be formed already when parting the heater meander. In this respect the contact points can be arranged in the longitudinal direction at the same end of the heater element, so that the later wiring can take place particularly easily from one side.

Furthermore, the heater meander can also be provided with three contact points, whereby the first contact point is formed on one end of the heater meander, the second contact point on the other end of the heater meander and the third contact point is formed as a contact strip arranged in a heater meander region between the two ends. The advantage of an embodiment with three contact points is that one heater meander is subdivided into two separate switchable heater circuits. In this manner either only the region from one of the outer contact points to the central contact point can be operated with a low heating power or the complete heater meander area from one end to the other end can be operated at high power. Furthermore, it is also possible to switch the two circuits of the heater meander in series and to operate them accordingly at a lower power.

Of course, the heater meander can also be subdivided into more than two heater circuits by producing a larger number of contact points.

In order to be able to simply fit the folded heater element according to the invention to a straight holding means for stabilisation, at least one part of the connection zones can be arranged aligned in the longitudinal direction. Furthermore, the connection zones can be arranged cyclically aligned in a number of parallel lines. In addition, the connection zones can be arranged alternately in each case in a connection zone plane running in the longitudinal direction, whereby the connection zone planes are aligned parallel to one another. This has the advantage that the folded heater element can be fitted to two parallel plate shaped holding means.

According to a further embodiment, the heater element with a number of connection zones can be fitted to at least one mounting body. The mounting fixes the folded spatial structure and can thus be more easily inserted into a heating appliance. In this regard, it is particularly advantageous that the fitting to the mounting body can take place directly following the shaping of the heater meander in one working step. Thus, the folded heater element is formed into its spatial structure and fixed in this structure. A particularly simple type of mounting is obtained in that the connection zones are pushed through mounting openings in the mounting body and butt-strapped in the mounting openings. Thus the heater element is connected to the mounting body in only one further shaping step. Therefore, no additional working step, such as for example gluing, stamping or welding of the heater element to the mounting body, is necessary.

Furthermore, the folded heater element can be manufactured from a heater substance, preferably a heater alloy, such as for example CrFeAl, to improve the service life and the heating properties.

In order to adapt the folded heater element to a fluid flow with different flow profile, i.e., with differing intensity of flow over the cross-section, the heater meander in a particularly advantageous embodiment can comprise different heater zones, which differ in the spacing of the parting edges of the heater limbs. Due to the different spacing in the heater zones, which leads to a different material width, the electrical resistance and therefore the heating power in one heating zone of the heater element is different to that in other heating zones. Consequently, certain regions of the fluid flow are heated stronger and others weaker, depending on through which heating zone of the folded heater element they flow.

In order that the folded heater element heats less strongly on the connection zones in which the folded heater element can be mounted, the distance between the parting edges of one of the connection zones can be larger than the distance between the parting edges of the two connected heater limbs. In this way the material width and thus the electrical resistance of the heater meander is greater in the region of the connection zone than in the region of the heater limb. Thus, when operating the heater element the connection zones are heated less strongly due to the larger electrical resistance, which also prevents overheating of the mounting body connected to the connection zones.

Finally, also the unit of the mounting body and heater element can be fitted to a holding device. The holding device, for example a housing or frame, can then be simply handled, it protects the spatially folded heater element and simplifies the fitting of the folded heater element into a heating appliance.

Apart from the folded heater elements and their manufacturing methods mentioned above, the invention also relates to a heating appliance for heating a flowing fluid, with at least one heater element through which the fluid can flow, which is formed from at least one heater meander with heater limbs connected to one another at the ends in connection zones, and with at least one mounting plate, to which the connection zones of the heater element are connected, whereby the heater element is arranged as a folded heater element according to one of the above mentioned embodiments. The heating appliance can thus be preassembled as a separate module unit and then, for example, be inserted into the flow channel of a tumble dryer.

In an advantageous embodiment of the heating appliance according to the invention, it can comprise an essentially cuboid-shaped frame module on which the at least one mounting plate is held and which the folded heater element surrounds. In this way, the folded heater element is held particularly simply and stably. Furthermore, the mounting plate can be manufactured from an insulating material, e.g., micanite, for example to prevent a short circuit due to leakage currents.

On the frame module of the heating appliance according to the invention a mounting region can furthermore be formed, such as for example a flange region, with which the heating appliance can be particularly simply mounted in a fluid flow which is to be heated, for example in the flow channel of a tumble dryer or a fan heater.

To effectively heat the fluid flow which is to be heated, the heating appliance can be formed in at least one flow direction open towards the outside and the fluid flow which is to be heated can flow through it. Furthermore, the heating appliance can be formed in at least one second flow direction open towards the outside and the fluid flow to be heated can flow through it, whereby the flow directions run orthogonally to one another. In this way the heating appliance according to the invention can be fitted especially variably and thus has a large field of use.

### BRIEF DESCRIPTION OF THE SEVERAL VIEWS OF THE DRAWINGS

In the following the invention is explained using examples with reference to the accompanying drawings. The various features can be combined or omitted independently of one another, as has been already shown above with the individual advantageous embodiments.

The following are shown:

FIGS. 1a-c are schematic, perspective views of a first example of an embodiment of a folded heater element and its manufacture, according to some embodiments;

FIG. 1d is a sectional illustration along A-A through the folded heater element of FIG. 1c;

FIGS. 2a-c are schematic, perspective views of a second embodiment of a folded heater element;

FIG. 2d is a sectional illustration along B-B of the example of the folded heater element of FIG. 2c;

FIGS. 3a-c are schematic illustrations of a third embodiment of a folded heater element and its manufacture, according to some embodiments;

FIG. 3d is a sectional illustration along C-C of the embodiment of FIG. 3c after displacement of the connection zones;

FIG. 4a is a schematic illustration of a fourth embodiment of a folded heater element according to the invention and its manufacture;

FIG. 4b is a sectional illustration along D-D of the embodiment of FIG. 4a after displacement of the connection zones;

FIGS. 5a-d are schematic, perspective illustrations of a fifth embodiment of a folded heater element according to the invention and its manufacture;

FIGS. 6a-c are schematic illustrations of the mounting of the heater element of FIG. 5 on mounting plates;

FIG. 7 is a schematic, perspective illustration of a heating appliance according to the invention in an example of an embodiment;

FIG. 8 is a further embodiment of a folded heater element according to the invention in a schematic illustration.

### DETAILED DESCRIPTION OF THE INVENTION

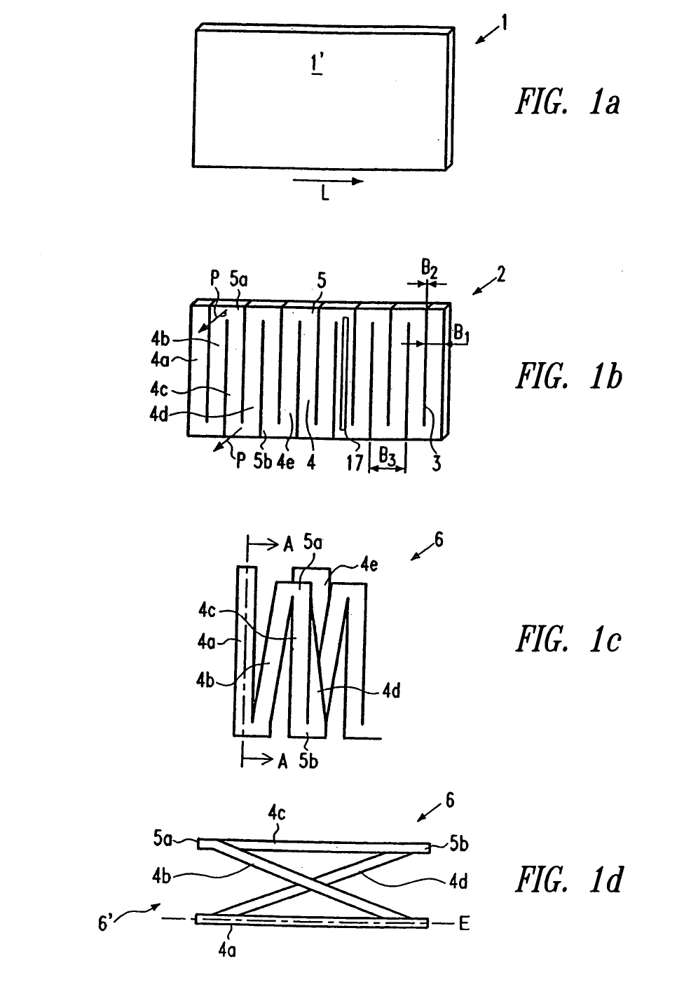

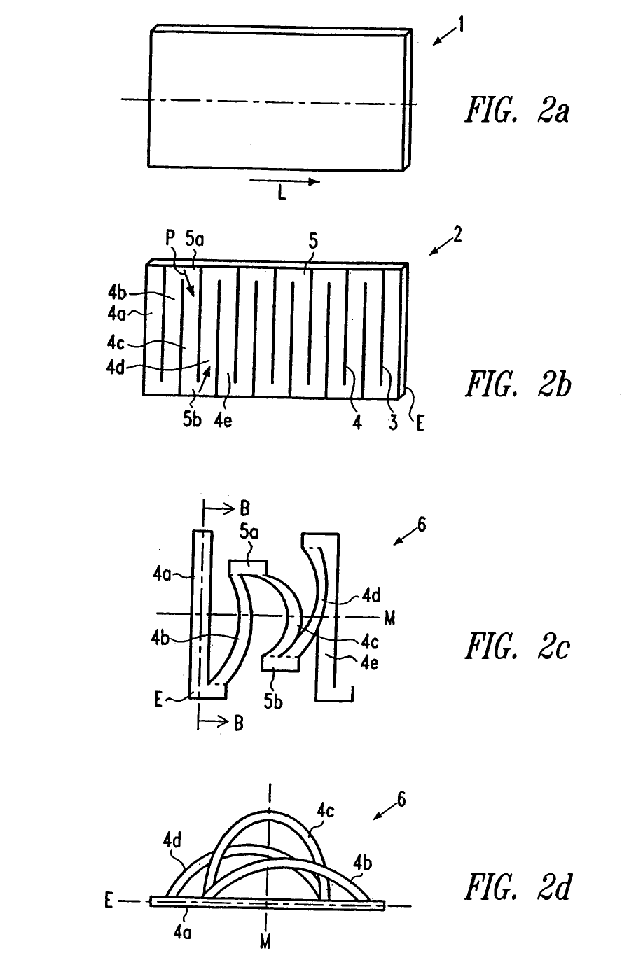

With reference to FIGS. 1a-2d first a manufacturing method according to the invention will be described in which folded heater elements with a through-flow spatial structure are manufactured from an essentially planar heater meander in which connection zones of the heater meander are displaced.

The initial material for the manufacture is a flat track material 1 of a heater substance, such as for example a metal or a metallic alloy which heats up due to its electrical resistance once electrical energy passes through it. The track material 1 extends along a generally planar initial surface 1′ in a longitudinal direction L.

The first production process illustrated in FIGS. 1a and 1b is the manufacture of a heater meander 2 by parting the track material 1. During the parting process, the track material 1 is cut or slit at the parting edges 3. The parting edges 3 extend essentially perpendicular to the longitudinal direction L and slit the track material 1 alternately from one edge almost to the opposite edge.

In this way a heater meander 2 with heater limbs 4 and connection zones 5 is produced from the plate-shaped track material 1. The heater meander 2 is a strip heater or heater conductor which runs in a meander shape. The heater limbs 4 extend between the parting edges 3 and thus form in each case a linear heater strip, the width B1 of which corresponds to the distance B₁ between two parting edges 3. The distance B, between the parting edges 3 is greater than the distance B₂ between the adjacent parting edges 3 of the neighbouring heater limbs 4. The heater limbs 4 are connected in the edge region of the heater meander 2 to connection zones 5. The connection zones 5 are the plate-shaped regions at the edge of the heater meander 2 at which in each case two limbs 4 are connected together and the run of the heater meander 2 is deflected by about 180°.

In the embodiment of FIG. 1b all the connection zones 5 lie on two parallel straight lines, which in each case extend substantially parallel to the longitudinal direction L at one edge of the heater meander 2. The distances between adjacent parting edges 3 can be substantially equal to one another so that the heater limbs 4 have the same width B₁. For increased the stability, stiffening profiles, such as for example crimps 17, can be formed in the heater limbs 4. The crimps 17 can be substantially parallel to the parting edges 3.

Next, at least some of the connection zones 5 of the heater meander 2 are displaced. In FIGS. 1a and 1b the connection zones 5a and 5b are, for example, offset perpendicular to the planar initial surface 1′ of the heater meander 2. In this way the planar heater meander 2 is shaped into a folded heater element 6 and takes on a through-flow spatial structure 6′.

Due to the deflection of the one connection zone 5a perpendicular to the plane E of the initial surface of the heater meander 2, the heater limb 4b is tilted up and splayed out with respect to the heater limb 4a, which remains in the initial surface. In this way the heater limbs 4a and 4b, which were originally arranged at the parting edge 3 directly adjacent one another, are separated from one another spatially and moved relative to one another. Therefore, the danger of a contact between these two heater limbs 4a, 4b when operating the folded heater element 6 is eliminated.

The connection zone 5b of the folded heater element 6 is offset by the same distance as the connection zone 5a from the initial surface E of the heater meander 2. Therefore the heater limb 4c, which extends between the connection zone 5a and the connection zone 5b, extends substantially parallel to the heater limb 4a, which as before is located in the original initial surface of the track material 1. However the heater limb 4c is offset by the distance by which the connection zones 5a and 5b are displaced from the initial surface.

The heater limb 4d following the heater limb 4c in the longitudinal direction L leads the heater meanders 2 from the displaced position of the connection zone 5b back into the plane E of the initial surface 1′.

Due to the displacement of the two connection zones 5a and 5b and the splaying out of the heater limbs 4, a folded heater element 6 thus arises with a through-flow spatial structure in which the adjacent heater limbs 4a to 4d are spatially arranged such that contacts in operation are prevented.

FIG. 1d shows a schematic sectional illustration along the section A-A from FIG. 1c in order to illustrate the spatial structure 6′ in the direction of the longitudinal axis L. As shown in FIG. 1d, a heater network is formed from heater limbs 4 which cross in the projection.

FIGS. 2a-d are schematic illustrations of another embodiment of a folded heater element 6 a method for producing the same. For the sake of clarity only the differences to the embodiment of FIGS. 1a-1d are explained. The same reference numerals are used as in FIGS. 1a-1d for the same parts having a similar or identical construction and/or function as parts of the previous embodiment.

The heater meander 2 of this embodiment is manufactured just as the heater meander illustrated in FIGS. 1a-d. The different spatial arrangement of the folded heater element 6 of FIG. 2a is obtained by a variation in the displacement of the connection zones 5a and 5d.

Whereas the connection zones 5a and 5b in FIG. 1d are displaced perpendicular to the plane E of the initial surface 1′ of the heater meander 2, the heater element 6 of FIG. 2c is formed through displacement of the connection zones 5a and 5b within the plane E. As the arrows indicate, both connection zones 5a and 5b are moved from their initial position on the edge of the heater meander 2 with respect to other connection zones 5 along two spatial axes. The first movement occurs in the direction of the longitudinal axis L of the track material 1, whereby first no spatial structure arises, but the heater limbs 4a to 4d are pulled apart in the longitudinal direction L. In this way a planar heater meander 6 is formed, the heater limbs 4a to 4d of which are no longer arranged parallel and bordering the parting edges 3, but rather they are spaced from one another and run in a zigzag shape.

The second translation direction along which the connection zones 5a and 5b are offset, runs in the plane E of the initial surface and perpendicular to the longitudinal axis L. Here, both connection zones 5a and 5b are offset in opposite directions by approximately the width of a connection zone 5 in the direction towards the centre of the track material 1.

Due to the movement of the connection zones 5a and 5b towards one another, the heater limbs 4b to 4d, which are connected to at least one of the connection zones 5a or 5b, are displaced out of the plane E. Here, the heater limbs 4b to 4d are shaped to form arc-shaped heater strips, which protrude from the plane E of the initial surface, as illustrated in FIG. 2a.

With the folded heater element 6 of FIG. 2a the heater arcs 4b to 4d all protrude on the same side from the initial surface of the track material 1. Of course, it is also possible to displace heater limbs 4a to 4d from the initial surface alternately in opposite directions.

The embodiment of FIGS. 2c and 2d has a spatial structure folded heater element 6. The heater element 6 includes both of the planar heater limbs 4a, 4e, which are not perpendicular to the longitudinal axis 11, as well as the arc-shaped heater limbs 4b to 4d. The heater limb 4c, which is connected to the two connection zones 5a and 5b that are displaced perpendicular to the longitudinal axis L, forms an arc, which runs symmetrically to the longitudinal central axis M of the track material 1 and protrudes further from the plane E in comparison to the arcs of the other shaped heater limbs 4b and 4d.

The heater strips 4b and 4d also form an arc structure protruding into space from the plane E, but these two heater limbs are only connected to one displaced connection zone 5a or 5b. For this reason the two heater limbs 5b and 5d protrude less from the plane E than the heater limb 5c. Furthermore, the two heater limbs 4b and 4d are not symmetrical to the longitudinal central axis M, but rather in each case they are displaced to one side of this central axis M.

In FIG. 2d the connection zone 5a (in this illustration covered by the heater limb 4a) is displaced to the right from the left edge of the illustration. Therefore the crest of the heater arc of the heater limb 4b is located to the right of the central longitudinal axis M of the folded heater element 6. The displacement of the similarly obscured connection zone 5b from the right edge of FIG. 2d in the direction of the central axis M causes the arc-shaped run of the displaced heater limb 4c. Since both connection zones 5a and 5b, on which this heater limb terminates, are moved in the direction of the central axis M from the edge of the heater meander 2, this heater limb 4c in turn protrudes symmetrically to the central axis M from the plane E. The third displaced heater limb 4d is located symmetrically to the heater limb 4b with respect to the central axis M.

The embodiments of FIGS. 1a to 2d illustrate different embodiments of a folded heater element 6 according to some embodiments of the invention. In both cases a through flow spatial structure of a folded heater element 6 is manufactured by the displacement of some connection zones 5 with respect to other connection zones of a heater meander 2. Displacement of the connection zones 5, one in the plane E and one perpendicular to the plane E, make it possible to manufacture many differently designed heater elements 6 with different spatial structures.

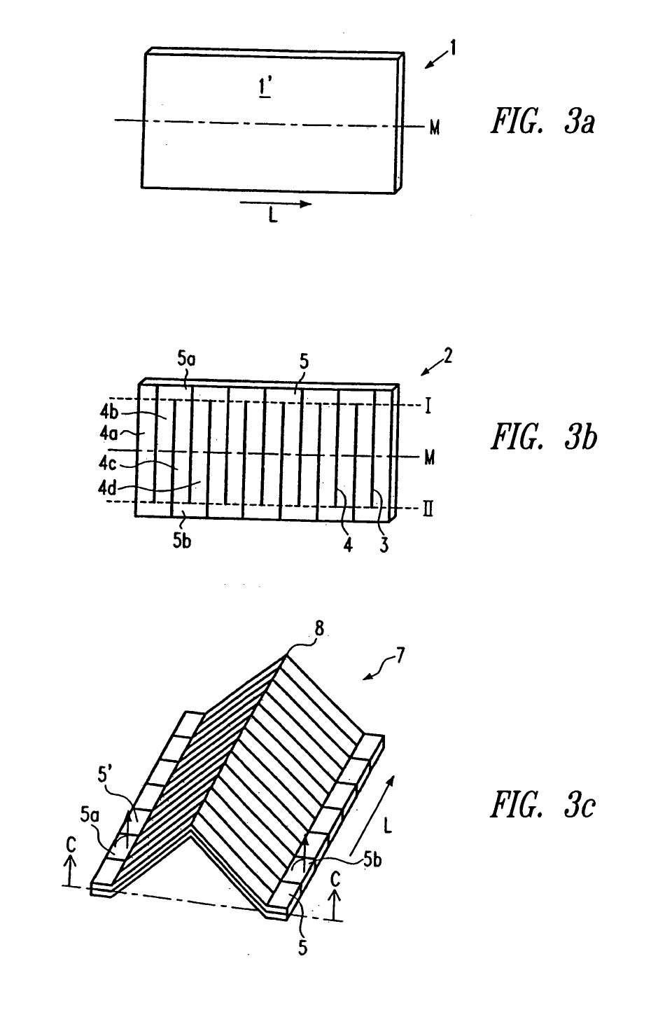

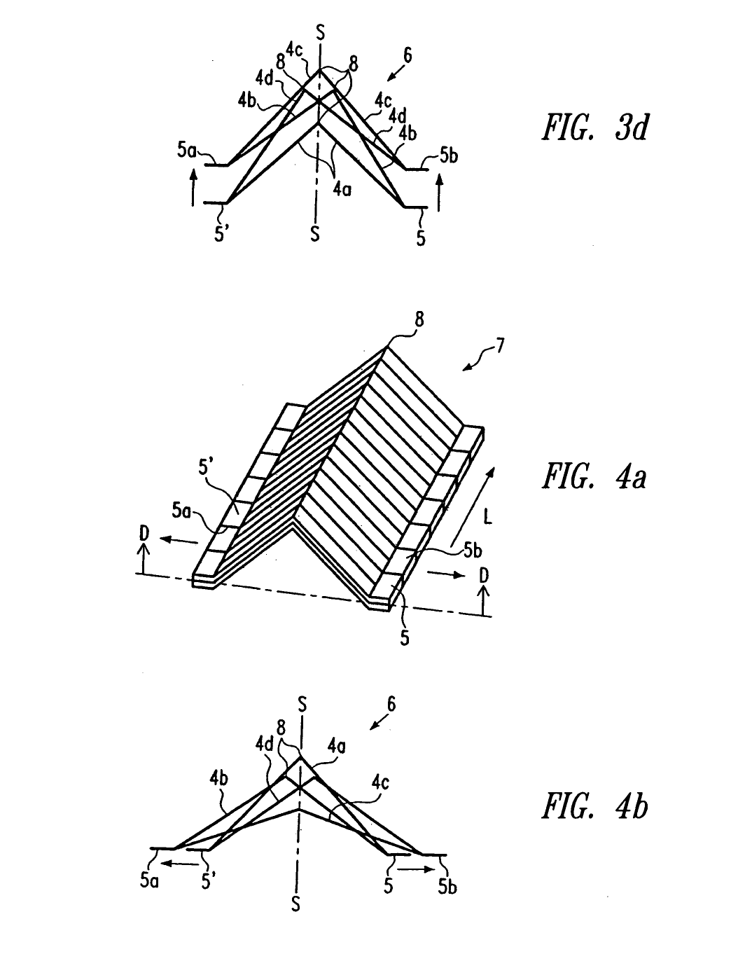

FIGS. 3a-d shows a schematic illustration of a third embodiment as an example of a folded heater element 6 according to the invention. Once more only the differences to the embodiments described above are explained. The same reference numerals are used as in the preceding figures for the same parts having a similar or identical construction and/or function as parts of the previous embodiments.

The difference of the embodiment in FIGS. 3a-d compared to the previous embodiments is that shaping of the essentially planar track material occurs before the displacement of the connection zones out of the plane E. Once the planar heater meander 2 has been produced by parting at the parting edges 3, the embodiment of FIG. 3b is then shaped into a spatial structure 7 of FIG. 3c. The spatial structure 7 differs from the planar heater meander 2 in that it is folded at a folding point 8 in the region of the heater limb 4. In the embodiment illustrated in FIG. 3c, the folding point 8 is the point of each heater limb 4 which has the maximum distance to a straight line through the connection zones 5 of this heater limb 4. The folding point 8 can exhibit a radius to prevent weakening of the material.

In FIG. 3b the heater meander 2 is folded or turned over along three folding axes I, M II and reshaped to form the angular spatial area 7 of FIG. 3c. Alternatively, the heater meander 2 can be shaped in any spatial area 7 in which the heater limbs 4 are each displaced non-linearly between the connection zones 5 in the cross-section to the longitudinal direction L. Apart from the angular bent displacement, it can, for example, be arc-shaped or U-shaped.

In a further reshaping process, which comprises the displacement of the connection zones 5a and 5b out of the spatial area 7 and opposite the rest of the connection zones 5, the final spatial arrangement of the folded heater element 6 is produced. In the embodiment of FIGS. 3c-d the connection zones 5a and 5b are offset perpendicular to the original initial surface of the track material 1. This act in the method corresponds essentially to the displacement stage which is described in FIGS. 1b-1c on the planar heater meander 2.

FIG. 3d is a sectional illustration along the sectional plane C-C in FIG. 3c after displacement. FIG. 3d shows the heater network of heater limbs 4 of the folded heater element 6 which cross in a projection in the longitudinal direction L. The connection zones 5 and 5′, which are not displaced, are located as before in the original initial surface of the track material 1. The heater limb 4a is moved out of the original initial surface and runs in an angular shape between the connection zones 5 and 5′. Here, the heater limb 4a comprises two straight sections which each run between the connection zones 5 or 5′ and the bending point 8. The run of the connection zones 5 and 5′ illustrated in FIG. 3d with the angular heater limb 4a thus represents the profile or the cross-section of the spatial area 7 before the displacement of the connection zones.

One connection zone 5a is arranged on the same edge as the connection zone 5′, but offset upwards relative to the initial surface. Consequently, the heater limb 4b, which exhibits the same angular profile as the other heater limbs 4a, is moved out of the initial surface. The offsetting of the connection zone 5a results in the heater limb 4b being raised on one side, on the left side in the illustrated example, whereby the angular shape of the heater limb 4b is displaced to the top right relative to the heater limb 4a. Here the bending point 8 of the heater limb 4b moves on the circle drawn around a connection point of the heater limb 4b with the connection zone 5, whereby the radius is the distance between the connection point 5 and the bending point 8 of the heater limb 4a.

Overall the right section of the heater limb 4b runs steeper than the right section of the heater limb 4a, the bending point of the heater limb 4b is located further upwards and to the right of the bending point of the heater limb 4a and the left section of the heater limb 4b runs above but less steep than the left section of the heater limb 4a.

The heater limb 4c follows the heater limb 4b when the meander shaped run of the heater meander 2 folded to the spatial area 7 is considered. The heater limb 4c is arranged between the connection zones 5a and 5b, which are both offset perpendicular to the initial surface of the track material 1. FIG. 3d shows that the two connection zones 5a and 5b are offset by the same distance from the connection zones 5 and 5′, respectively. The connection zones 5 and 5′ are not displaced. Therefore the third heater limb 4c extends parallel to the heater limb 4a, but is raised by the same distance that separates that connection zones 5a and 5b and the connection zones 5 and 5′. The fourth heater limb 4d follows the meander run to the heater limb 5c and is located between the displaced connection zone 5d and connection zone 5′, which is not displaced. The heater limb 4d is also moved out exactly as the heater limb 4b on one side out of the initial surface. In contrast to the heater limb 4b, the heater limb 4d is on the right side and thus moved to the top left. The heater limb 4d is arranged symmetrically to the heater limb 4a with respect to a line of symmetry S of FIG. 3d. Overall the projection in the longitudinal direction L of the folded heater element 6 in FIG. 3d is symmetrical with respect to the line of symmetry S.

FIGS. 4a-b show a another embodiment of a folded heater element. The embodiment of FIGS. 4a and 4b generally corresponds to the folded heater element of FIGS. 3a-d, but the two embodiments differ in the displacement of the connection zones 5 relative to one another. Again, only the differences to the embodiments described above are explained and for parts having a construction and/or function which is similar or identical to parts of the previous embodiment, the same reference numerals are used as in the preceding figures.

Up to the formation of the heater meander 2 folded in the spatial area 7, the manufacture of the folded heater element 6 of FIG. 4a runs identical to the embodiment of FIG. 3c.

In contrast to the embodiment of FIG. 3d the displacement of the connection zones 5a and 5b this time does not take place essentially perpendicular to the initial surface, but rather within the essentially planar surface, as shown in FIG. 4b. Here, both of the connection zones 5a and 5b are offset generally perpendicular to the longitudinal direction L (FIG. 4a) of the folded heater meander 7 in that the two connection zones 5a and 5b are pulled apart.

In this manner another embodiment of a heater element 6 is formed, the profile of which viewed in the longitudinal direction L is shown in FIG. 4b.

FIG. 4b is a sectional illustration of FIG. 4a after offset along the sectional axis D-D. The profile of the spatially shaped heater meander 6 of FIG. 4b is similar to the run of FIG. 3b. The difference is that due to the splaying out of the connection zones 5a and 5b the angular structure of the heater limbs 4b to 4d is also changed. The heater limb 4a, which extends between the connection zone 5 and the connection zone 5′, corresponds to the heater limb 4a of FIG. 3b. The following second heater limb 4b forms a more obtuse angle than the heater limb 4a. Since only the connection zone 5a of the two connection zones 5a and 5 connected to the heater limb 4b is displaced outwards, the bend 8 in comparison to the bend 8 of the heater limb 4a is located further to the lower left.

The third heater limb 4c extends between the two displaced connection zones 5a and 5b. Therefore, the heater limb 4c does not protrude very far out of the initial surface. In the illustrated embodiment of FIG. 4b, the initial surface is defined by a plane extending through the four connection zones 5, 5′, 5a and 5b. The heater limb 4c forms a shallow angle, the bending point 8 of which is located closer to the initial surface than the other bending points 8.

The fourth heater limb 4d runs between the connection zone 5′ and the connection zone 5b which is displaced to the right. The run of the heater limb 4d thus corresponds in principle to the run of the heater limb 4b with the difference that this time the bending point 8 is displaced to the right and not to the left. Also the folded heater element 6 illustrated in FIG. 4b is constructed symmetrically to a line of symmetry S.

Despite the quite similar spatial structure of the folded heater elements 6 of FIGS. 3a-d and 4a-b, there are differences, in particular with regard to the mounting of the folded heater elements 6 on a mounting body, for example an insulating mounting plate. Since all the connection zones 5 of the embodiment of FIG. 4b are located in the initial surface of the track material 1, the folded heater element 6 can be fitted to a single insulation plate (not shown) running in the initial surface.

With the embodiment of FIG. 3d the connection zones 5a and 5b are essentially offset perpendicular to the initial surface, so that mounting on a single mounting plate may not be suitable. In this case, the folded heater element 6 can be fixed between two substantially parallel mounting plates. On the first mounting plate the connection zones 5a and 5′ can be fitted as well as the connection zones of the embodiment in FIG. 3a, which are located further on one side of the spatial structure 7. The remaining connection zones located on the other side can be mounted on a further mounting plate which is located parallel to the first one on the other side of the folded heater element 6.

Basically, with the previously described embodiments it should be said that of course not only two connection zones can be displaced relative to the other connection zones, but rather that for example two directly consecutive connection zones can be displaced in pairs. In some embodiments, two consecutive connection zones are alternately displaced in pairs with respect to the next two connection zones. Thus, all heater limbs 4 are spaced from one another and contact in operation is avoided.

Furthermore, single heater limbs or single sections of the heater meander 2 are produced with especially wide or especially narrow heater limbs 4. In this way there is the possibility of relatively easily subdividing the heating power of the folded heater element 6 into different heater zones and of adapting the requirements to the heater element 6.

The material width B₃ of the connection zones 5 is larger than the width B, of the heater limb 4 so that the connection zones 5 heat up less strongly in operation due to the larger electrical resistance. Thus, for example, overheating of a mounting body connected to the connection zones 5 can be prevented.

Furthermore, it is also not necessary to arrange all heater limbs 4 of the heater meander 2 parallel to one another or for them to have the same length.

FIGS. 5a-5d show another embodiment of a folded heater element 6. Again, only the differences to the embodiments described above are explained. The same reference numerals are used as in the preceding figures for the same parts having a similar or identical construction and/or function as parts of the previous embodiments.

In contrast to the preceding embodiments, the illustrated embodiments of FIGS. 5a-5d not one meander loop, but rather two meander loops 2a and 2b are parted in the track shaped initial material. The two heater meanders 2a and 2b each correspond to the heater meanders 2 of the preceding embodiments.

The two meander shaped strip heaters 2a and 2b both extend in the longitudinal direction L of the original track material and are arranged parallel to one another. With both heater meanders 2a and 2b the straight heater limbs 4 run transverse to the longitudinal direction L and are connected via connection zones 5, which are located arranged on the edges of the two heater meanders 2a and 2b.

One end of the first heater meander 2a is connected at a connection point 9 to one end of the other heater meander 2b. In this way the two heater meanders 2a and 2b form a continuous, through-flow heater meander 2, which is connected together via the connecting section 9. At the two other ends of the heater meander, which are not connected via the connection point 9, contact lugs 10a and 10b are formed. The contact lugs 10a and 10b protrude from the rectangular shape of the two heater meanders 2a and 2b as plate shaped protrusions. A further contact strip 11 runs from the connecting section 9 parallel to the longitudinal axis L between the two heater meanders 2a and 2b.

The only point at which wastage arises during the parting step of the embodiment of FIG. 5, with which the heater meanders 2a and 2b are produced from the track material 1, are the regions between the heater meanders 2a and 2b and the contact strip 10. However, during the manufacture of the two heater meanders 2a and 2b by parting the track material, essentially no wastage occurs.

In a first reshaping process the two heater meanders 2a and 2b are folded into a spatial area 7, as discussed in connection with the embodiments illustrated in FIGS. 3a-d and FIGS. 4a-b. To achieve this, folding occurs along six folding lines I to VI.

The first folding line I runs along the transition zone between the connection zones 5′, which point outwards, and the heater limbs 4 of the heater meander 2a. The second folding line extends in the longitudinal direction L centrally through the heater meander 2a, whereby the heater limb 4 is subdivided into two heater limb sections 4′ and 4″. The third folding line III extends finally along the transition zone between the connection zones 5″ and the heater limb sections 4″.

The other heater meander 2b is also folded in a corresponding manner along the folding lines IV to VI, whereby also with this heater meander 2b the heater limb 4 is subdivided into two equally large heating sections 4′″ and 4″″. FIG. 5b shows the thus folded meander strip heater 2a and 2b in profile viewed along the longitudinal axis L.

FIG. 5b shows that both heater meanders 2a and 2b are each folded into a spatial area 7, which respectively correspond to the spatial area 7 of FIGS. 3a-4b with the angular structure. The two spatial areas 7a and 7b are connected together via the connecting section 9. In FIG. 5b to the side of the connecting section 9 are located the connection zones 5″ of one heater meander 2a and the connection zones 5′″ of the second heater meander 2b arranged opposite one another. In the same way the other connection zones 5′ of the first heater meander 2a and the connection zones 5″″ of the other heater meander 2b are located spaced opposite one another.

The angles, formed from the heater limb sections 4′ and 4″, respectively 4′″ and 4″″, exhibit bending points 8a and 8b there where the heater meanders 2a and 2b have been bent along the folding lines 11, respectively V. In the profile of FIG. 5b the bending points 8a and 8b each point in opposite directions outwards.

The next act in the manufacturing method is displacement (see FIG. 5c) of single connection zones 5′ to 5″″ compared to other connection zones 5, corresponding to the method of the embodiment from FIG. 3d. If a displacement plane is defined by the connection zones 5′ and 5″ or by the connection zones 5′″ and 5″″, then single connection zones are displaced outwards perpendicular out of this displacement plane, i.e., in the direction of the bending points. In this way the profiles already described in FIG. 3d arise.

FIG. 5d shows the spatial structure of the folded heater element from FIG. 5c in a perspective view. As can be seen in FIG. 5d, the connection zones 5 of each heater meander 2 are aligned cyclically to one another. A connection zone angle α between the two heater limbs 4 of each single connection zone 5 is the same on all connection zones of this embodiment of the folded heater element according to the invention.

FIGS. 6a-c illustrate how a folded heater element 6 of the embodiment of FIGS. 5c and 5d is fitted to mounting plates 12. For the sake of clarity only the differences to the embodiments described above are explained. The same reference numerals are used as in the preceding figures for the same parts having a similar or identical construction and/or function as parts of the previous embodiments.

The mounting of the folded heater element 6 occurs on the connection zones 5′ to 5″″ or on the displaced connection zones 5′_{A} to 5″″_{A}. To achieve this, two mounting plates 12, which are also used at the same time as electrical insulating plates, are provided with insertion slits 13 such that the two insulating plates 12 can accommodate all connection zones 5 of the folded heater element 6 in the insertion slits 13.

One mounting plate 12 accommodates the connection zones 5″_{A}, 5″, 5′″ and 5′″_{A}, which lie in one plane, in their insertion slits 13. This is possible because these four rows of connection zones are located in one connection zone plane.

In an analogous manner the second insulation plate 12 with the insertion slits 13 can accommodate the connection zones 5′_{A}, 5′, 5″″, 5″″_{A} located in a second parallel connection zone plane. In this state the two mounting plates 12 are located at the transition zones between the connection zones 5 and the heater limbs 4. By simply turning over, i.e., butt-strapping, the connection zones 5 the folded heater element 6 can be fitted in a very simple manner to the plates 12.

FIG. 6b illustrates the mounting pattern of the connection zones 5′_{A}, 5′, 5″″ and 5″″_{A} on one mounting plate 12. In this respect the folded heater element 6 fitted to the mounting plates 12 is illustrated viewed perpendicular to the mounting plate 12 on the butt-strapped connection zones.

It can be clearly seen that each second connection zone has been offset out of the displacement plane. Furthermore, it can be seen that the contact lugs 10a and 10b as well as the contact strip 11 extend to the side beyond the edge of the mounting plates 12, so that simple electrical contacting can be established.

FIG. 6c is a perspective view of the folded heater element 6 of FIGS. 6a and 6b. The electrical connection of the folded heater element 6 occurs via the contact points 10a, 10b, which cannot be seen in FIG. 6c, and the contact strip 11. Various power selections of the folded heater element 6 are possible using these three possible connection methods. Either the folded heater element 6 can be operated at high power with two separate switchable, parallel heater circuits, each between one of the contact points 10a, 10b and the contact strip 11, or at reduced power with one heater circuit, in series, between the contact points 10a and 10b.

FIG. 7 shows an embodiment as an example of a heating appliance 14 in which the folded heater element 6 from FIG. 6c, mounted between the mounting plates 12, is fitted in an essentially cuboid frame module 15. The fluid to be heated can flow through the heating appliance 14, which for example can be used in a flow channel of a tumble dryer, a fan heater or an industrial hot blower. Since the frame module 15 exhibits through-flow openings except on the sides facing the mounting plates 12, the fluid can flow through the heating appliance 14 in a first flow direction S1 parallel to the longitudinal direction of the folded heater element 6 or in a flow direction S2 transverse to the longitudinal direction L. Of course, other flow directions are also possible, which lie in a plane defined by the flow directions S1 and S2.

The heating appliance 15 according to the invention exhibits different flow resistances in the two flow directions S1 and S2. In the flow direction S1, in which the folded heater element 6 forms a channel with a relatively large flow opening, the flow resistance is lower than in the flow direction S2, in which the heater limbs 4 of the folded heater element 6 form a grid with smaller flow openings. Due to the different flow resistances a relatively large amount of fluid is slightly heated in the flow direction S1, whereas in the flow direction S2 a smaller amount of fluid is more strongly heated and more strongly churned up. From this, different possible uses arise for the heating appliance according to the invention.

The frame module 15 is provided with mounting holes 17 in a flange region 16. The heating appliance 14 can for example be used in an opening of the flow channel and joined to the flow channel in the flange region 16 by joining means, such as for example screws or rivets.

Of course, the invention is not restricted to just the embodiments illustrated in the figures. Thus, for example, heater meanders can be produced, the heater limbs 4 of which do not run parallel and exhibit different lengths. Furthermore, it is also possible to displace connection zones 5 at different distances or to offset them both perpendicular to the displacement surface as well as in a displacement surface. It is also possible to fit the folded heater element 6, mounted on mounting plates 12, additionally in a housing, so that the unit of the folded heater element 6 and the mounting plates 12 is accommodated in this housing and mounted on it.

FIG. 8 shows another embodiment of a folded heater element 6. The embodiment of FIG. 8 corresponds essentially to the folded heater element of FIGS. 3a-d, but the two embodiments differ in the displacement of the connection zones 5 relative to one another. For the sake of brevity only the differences to the embodiments already described are explained and for parts having a construction and/or function which is similar or identical to parts of the previous embodiment, the same reference numerals are used.

The manufacture of the folded heater element 6 of FIG. 8 is up to the act illustrated in FIG. 3c the same as the folded heater element 6 of FIG. 3c. As with the embodiment of FIG. 4b, the displacement of the connection zones 5 occurs within the essentially planar initial surface. In contrast to the embodiment of FIG. 4b, the connection zones 5 of FIG. 8 are offset in the longitudinal direction L. In achieving this, for example, the connection zones 5b and 5c are pulled apart in the longitudinal direction L. In this way, the heater limbs 4, which are connected together in a connection zone, are pulled apart or splayed out from one another.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of manufacturing a through-flow spatial structure in a folded heater element from a track material in an initial plane, the method comprising:
parting the track material into a plurality of separate heater limbs connected to one another at ends of connection zones so as to form a heater meander extending outwardly from the initial plane, the heater meander defining a through-flow spatial structure; and
offsetting at least some of the connection zones with respect to other connection zones such that the heater limbs connected to the connection zones are splayed out relatively with respect to one another.

2. The method according to claim 1 wherein the offsetting of the at least some of the connection zones and the splaying of the heater limbs produces a heating network of crossing heater limbs when viewed along a longitudinal axis of the heater meander.

3. The method according to claim 1 wherein the parting of the track material produces substantially no waste.

4. The method according to claim 1, further comprising:
displacing at least some of the connection zones within the initial plane.

5. The method according to claim 1, further comprising:
displacing at least some of the connection zones in a direction substantially perpendicular to the initial plane.

6. The method according to claim 1 wherein two connection zones, connected together via a heater limb, are displaced as a pairs.

7. The method according to claim 1 wherein the heater limbs are substantially linear and are manufactured by the parting of the track material.

8. The method according to claim 1, further comprising:
deforming the track material from the initial plane to a spatial area before the offsetting of the connection zones.

9. The method according to claim 8 wherein the spatial area is formed by longitudinally bending the heater limbs in a direction substantially perpendicular to the initial surface.

10. The method according to claim 1, further comprising:
bending each of the heater limbs at at least one bending point.

11. The method according to claim 1 wherein stiffening profile sections are formed in the track material.

12. The method according to claim 1 wherein, when forming the heater meander at least one contact point and/or a contact strip of the folded heater element is formed.

13. The method according to claim 1, further comprising:
fitting the folded heater element with the connection zones to at least one mounting body.

14. The method according to claim 13 wherein the fitting of the heater element to the at least one mounting body and the shaping of the track material occur generally at the same time.

15. The method according to claim 13, further comprising:
passing the connection zones through corresponding mounting openings of the mounting body; and
butt-stripping the connection zones in the corresponding mounting openings.

16. The method according to claim 13, further comprising:
fitting the mounting body and the folded heater element to a holding device.

17. The method according to claim 1 wherein the heater limbs between the connection zones are displaced to the same side of the initial plane.

18. A folded heater element with a spatial structure for fluid flow therethrough, the folded heater element configured for use in an electrical heating appliance so as to heat a flowing fluid, the folded heater element comprising:
at least one heater meander produced from a substantially planar track material, the at least one heater meander comprising:
a plurality of connection zones; and
a plurality of heater limbs, the heater limbs having parting edges and connected to one another by ends of the connection zones, the heater limbs being splayed outwardly, and the connection zones are spaced from one another.

19. The folded heater element according to claim 18, wherein the heater limbs form a heater network, in which the connection zones are offset from one another and projections of the heater limbs cross each other, wherein the projections of the heater limbs are taken along a longitudinal axis of the heater meander.

20. The folded heater element according to claim 18 wherein the heater limbs are shaped alternately in cross-section to a longitudinal direction in each case from a straight line between the connection zones.

21. The folded heater element according to claim 18, wherein each of the heater limbs has at least one longitudinal crimp.

22. The folded heater element according to claim 18, wherein a distance between the parting edges of one of the heater limbs is larger than the distances between adjacent parting edges of neighboring heater limbs.

23. The folded heater element according to claim 18, wherein the heater meander further comprises contact points and/or contact strips for electrical connection to an energy source, wherein the contact points and/or the contact strips are arranged in a longitudinal direction of the heater meander at one end of the folded heater element.

24. The folded heater element according to claim 23, wherein the heater meander is configured for fluid flow for producing different heating powers with electrical energy from one of the contact points in the direction of the contact strip, from both contact points in each case in the direction of the contact strip, or from one of the contact points in the direction of the other contact point.

25. The folded heater element according to claim 18, wherein at least some of the connection zones are aligned in a longitudinal direction of the heater meander.

26. The folded heater element according to claim 25, characterised in that wherein the connection zones are arranged cyclically on a plurality of parallel lines of alignment.

27. The folded heater element according to claim 18, wherein the connection zones are arranged alternately in at least two connection zone planes, wherein the at least two connection zone planes are generally parallel to one another and extend in a longitudinal direction of the folded heater.

28. The folded heater element according to claim 18, further comprising:
a plurality of heater meanders, each of the heater meanders having a heater network, and the heater meanders form a channel enclosed by their heater networks.

29. The folded heater element according to claim 18 wherein the folded heater element comprises CrFeAl.

30. The folded heater element according to claim 18 wherein the heater meander comprises heater zones, which differ in the distance between the parting edges of the heater limbs.

31. The folded heater element according to claim 18, wherein a distance between the parting edges of one of the connection zones is larger than a distance between the parting edges of the connected heater limbs.

32. A heating appliance for heating a flowing fluid, the heating appliance comprising at least one heater element arranged for the passage of fluid flow therethrough and at least one mounting plate, the at least one heater element is formed from at least one heater meander with heater limbs, connected together at ends of connection zones, the connection zones of the heater element are mounted to the at least one mounting plate, the least one heater meander produced from a substantially planar track material such that the heater limbs are splayed outwardly and the connection zones are spaced from one another.

33. The heating appliance according to claim 32 wherein the mounting plate comprises an electrical insulating material.

34. The heating appliance according to claim 32 of wherein the heating appliance comprises a cuboid frame module, on which the at least one mounting plate is held and which encloses the heater element.

35. The heating appliance according to claim 32 wherein the mounting plate comprises micanite.

36. A foldable heater element for heating a fluid flowing therethrough, the foldable heater element comprising:
a plurality of connection zones; and
a plurality of elongate heater limbs, each connection zone extending between one pair of the elongate heater limbs, and the heater limbs are splayed outwardly when the connection zones are spaced from one another so as to form a heater meander.

37. The foldable heater element of claim 36, wherein the foldable heater element is produced from a generally planar material, the material has a first edge, a second edge opposing the first edge, a set of first parting lines extending, inwardly from the first edge, and a set of second parting lines extending inwardly from the second edge, wherein each first parting line is interposed between one of the adjacent pairs of the second parting lines so as to form the plurality of elongate heater limbs and the plurality of connection zones.
